(19) United States
(12) Patent Application Publication
(10) Pub. No.: US 2025/0174684 A1
(43) Pub. Date: May 29, 2025

(54) Membrane Electrode Assembly Humidifying Method and Computer Readable Storage Medium

(71) Applicant: Robert Bosch GmbH, Stuttgart (DE)

(72) Inventor: Hao Zhang, Shanghai (CN)

(21) Appl. No.: 18/958,635

(22) Filed: Nov. 25, 2024

(30) Foreign Application Priority Data
Nov. 28, 2023 (CN) 2023 1160 5344.0

(51) Int. Cl. H01M 8/04119; H01M 8/1004

(52) U.S. Cl. CPC H01M 8/04134; H01M 8/1004

(57) ABSTRACT

A membrane electrode assembly humidifying method and a computer readable storage medium are disclosed. The membrane electrode assembly humidifying method includes (i) heating a membrane electrode assembly to a temperature greater than or equal to that of water vapor, (ii) directing the water vapor to both sides of the membrane electrode assembly to pass the water vapor through an anodic gas diffusion layer and a cathodic gas diffusion layer to reach a catalyst-coated membrane, and (iii) allowing a coolant to flow through both sides of the membrane electrode assembly to condense the water vapor reaching the catalyst-coated membrane into liquid water. The membrane electrode assembly humidifying method achieves efficient wetting of the membrane electrode assembly alone without subsequently combining with discharge activation as commonly used in the art, thereby shortening wetting time and saving wetting costs.

This application claims priority under 35 U.S.C. § 119 to patent application no. CN 2023 1160 5344.0, filed on Nov. 28, 2023 in China, the disclosure of which is incorporated herein by reference in its entirety.

The present disclosure relates to the field of protic exchange membrane fuel cell (PEMFC), and more particularly to a method for wetting a membrane electrode assembly (MEA) in the PEMFC during an activation phase.

### BACKGROUND

The membrane electrode assembly MEA is a core component of the protic exchange membrane fuel cell PEMFC, the performance of which largely determines the level of performance of the PEMFC. The performance of several major components of the MEA (gas diffusion layers, catalyst layers, and protic exchange membranes) and the MEA preparation process have a significant impact on its performance. In addition, in order for the PEMFC to quickly achieve its optimum operational performance upon commencement of work, it is often necessary to activate the prepared PEMFC before it can be shipped to end users for use. An important purpose of PEMFC activation is to humidify the MEA in order to ensure good ion conductivity, thereby improving the output performance of fuel cells.

In the prior art, the PEMFC is typically treated with at least one of pre-activation and discharge activation methods to improve the water content of the MEA. During the pre-activation process, the PEMFC is treated by boiling the MEA, PEMFC water injection or steep wetting and other methods, but the activation effect is not good. During discharge activation, water generated by reactions of anodic gas (typically hydrogen) and cathodic gas (typically air) causes the MEA to gradually be wetted; and meanwhile, an active site of a catalyst is increased, and the overall electrical resistance of a stack is reduced. However, the discharge activation process takes longer time and consumes more hydrogen, making it more costly.

To solve one or more problems present in the prior art, the present disclosure provides an MEA humidifying method.

### SUMMARY

An MEA humidifying method provided in the present disclosure is capable of achieving rapid wetting of the MEA, especially its catalyst-coated membrane (CCM). Moreover, the method is capable of being used alone without combining with the discharge process (i.e., current/voltage cycle) to achieve efficient wetting of the CCM, thereby shortening wetting time and saving wetting costs.

Specifically, the present disclosure provides a membrane electrode assembly humidifying method, the membrane electrode assembly comprising: a catalyst-coated membrane; and an anodic gas diffusion layer and a cathodic gas diffusion layer positioned on both sides of the catalyst-coated membrane, respectively, wherein the membrane electrode assembly humidifying method uses water vapor to humidify the membrane electrode assembly; and the membrane electrode assembly humidifying method comprising: step 102: heating the membrane electrode assembly to a temperature greater than or equal to that of the water vapor; step 104: directing the water vapor to both sides of the membrane electrode assembly to pass the water vapor through the anodic gas diffusion layer and the cathodic gas diffusion layer to reach the catalyst-coated membrane; and step 106: allowing a coolant to flow through both sides of the membrane electrode assembly to condense the water vapor reaching the catalyst-coated membrane into liquid water.

In one example, during the step 106, the water vapor in the step 104 is continuously directed to both sides of the membrane electrode assembly.

In one example, the water vapor used by the membrane electrode assembly humidifying method is saturated water vapor.

In one example, in the step 102, the saturated water vapor is used for heating the membrane electrode assembly.

In one example, the saturated water vapor used in the step 102 is from the same water vapor source as that used in the step 104.

In one example, a temperature of the saturated water vapor used in the step 102 is equal to a temperature of the water vapor used in the step 104.

In one example, in the step 106, a coolant flows through both sides of the membrane electrode assembly at a certain time interval.

In one example, the coolant flows through both sides of the membrane electrode assembly at a regular time interval.

In one example, a first polar plate and a second polar plate are formed on both sides of the membrane electrode assembly, respectively, an anodic gas channel for anodic gas to flow into the membrane electrode assembly and a coolant channel are formed in the first polar plate, a cathodic gas channel for cathodic gas to flow into the membrane electrode assembly and a coolant channel are formed in the second polar plate, wherein in the step 102, the membrane electrode assembly is heated by introducing saturated water vapor into at least one of the anodic gas channel and the coolant channel of the first polar plate and the cathodic gas channel and the coolant channel of the second polar plate.

In one example, in the step 104, the water vapor is introduced into the anodic gas channel of the first polar plate and the cathodic gas channel of the second polar plate to pass the water vapor through the anodic gas diffusion layer and the cathodic gas diffusion layer to reach the catalyst-coated membrane.

In one example, in the step 106, the coolant is caused to flow through the coolant channels of the first polar plate and the second polar plate to condense the water vapor reaching the catalyst-coated membrane into liquid water.

In one example, in the step 102, the membrane electrode assembly is heated to 100-105° C.; in the step 104, the water vapor is continuously introduced into the anodic gas channel of the first polar plate and the cathodic gas channel of the second polar plate for 10 minutes; and in the step 106, a coolant at 80° C. flows through the coolant channels of the first polar plate and the second polar plate for 30 seconds before stopping for 30 seconds, followed by starting to allow the coolant to flow through the coolant channels, such cycle is repeated for 15 times.

In one example, the membrane electrode assembly humidifying method further comprises: applying partial vacuum conditions to the saturated water vapor so that its temperature is below 100° C.

In one example, the coolant comprises deionized water.

The present disclosure also provides a computer readable storage medium having a program stored thereon, the program comprising instructions that, when executed by a processor, cause the processor to perform the membrane electrode assembly humidifying method according to any one above.

In general, various examples of the present disclosure may be combined and coupled in any possible manner within the scope of the present disclosure. These and other aspects, features, and/or advantages of the present disclosure will be apparent and set forth in reference to the examples illustrated below.

### BRIEF DESCRIPTION OF THE DRAWINGS

Embodiments of the present disclosure will be described by way of examples with reference to the following drawings, in which:

FIG. 1 shows a cross-sectional schematic view of a conventional protic exchange membrane fuel cell in the art, wherein an MEA humidifying method according to examples of the present disclosure is capable of being implemented in the protic exchange membrane fuel cell;

FIG. 2 shows a flow chart of an MEA humidifying method according to one example of the present disclosure; and

FIG. 3 shows a graph of relation of pressure versus temperature of saturated water vapor.

It will be understood that the accompanying drawing illustrates only one way in which the present disclosure is implemented and should not be construed as limiting other possible examples that fall within the scope of the appended claims.

### DETAILED DESCRIPTION

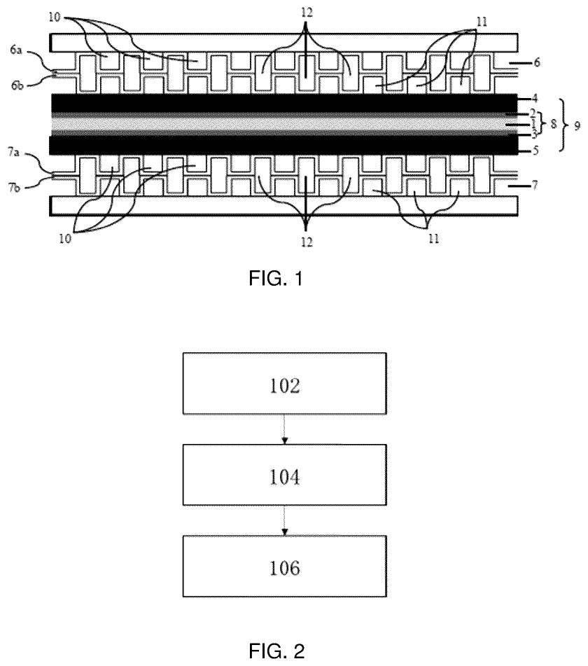

FIG. 1 shows a cross-sectional schematic view of a conventional protic exchange membrane fuel cell in the art, wherein an MEA humidifying method according to examples of the present disclosure is capable of being implemented in the protic exchange membrane fuel cell. A detailed description of the structure of the protic exchange membrane fuel cell is described below with reference to FIG. 1.

As shown in FIG. 1, the protic exchange membrane fuel cell generally includes a protic exchange membrane 1 located centrally, an anodic catalyst layer 2 and a cathodic catalyst layer 3 located on both sides of the protic exchange membrane 1, an anodic gas diffusion layer 4 and a cathodic gas diffusion layer 5 located on outer sides of the catalyst layers, and a first bipolar plate 6 and a second bipolar plate 7 located on outer sides of the gas diffusion layers. Among them, the protic exchange membrane 1, the anodic catalyst layer 2 and the cathodic catalyst layer 3 collectively constitute the catalyst-coated membrane CCM 8 as described above, while the CCM 8 and the anodic gas diffusion layer 4 as well as the cathodic gas diffusion layer 5 collectively constitute the membrane electrode assembly MEA 9 as described above.

It will be appreciated by those skilled in the art that additional MEAs (not shown in the figure) may be arranged on an upper side of the first bipolar plate 6 and a lower side of the second bipolar plate 7 to form a fuel cell stack comprising a plurality of fuel cell monomers. The MEA humidifying method according to the present disclosure may be implemented in any of the plurality of fuel cell monomers. Those skilled in the art will also appreciate that the first bipolar plate 6 may be an end plate for the fuel cell monomer on the uppermost side of the fuel cell stack, and the second bipolar plate 7 may be an end plate for the fuel cell monomer on the bottommost fuel cell stack. The bipolar plates 6, 7 described above and end plates may be collectively referred to as polar plates.

The first bipolar plate 6 and the second bipolar plate 7 may be of the same construction and may generally be formed by welding two sheets 6a and 6b, 7a and 7b with cross-sections formed as wave shapes or wall shapes, thereby forming a cathodic gas channel 10 on the upper side of the first sheet 6a, 7a, forming an anodic gas channel 11 on the lower side of the second sheet 6b, 7b, and forming a coolant channel 12 between the first sheet 6a, 7a and the second sheet 6b, 7b. The cathodic gas channel 10 is used to supply cathodic gas such as compressed air into the MEA 9, and the anodic gas channel 11 is used to supply anodic gas such as hydrogen into the MEA 9, such that an electrochemical reaction of oxygen and hydrogen occurs in the MEA 9 to generate electrical energy. The coolant channel 12 is used to allow the coolant such as water to flow through to take away a large amount of heat generated by the electrochemical reaction described above.

The protic exchange membrane 1 described above typically consists of perfluorosulfonic acid (PFSA) ion polymers, which are essentially copolymers of tetrafluoroethylene (TFE) and different perfluorosulfonic acid monomers. The most famous membrane materials are Nafion membranes produced by E.I. Du Pont Company, Dow Chemical Gore membranes, Dongyue membranes, etc. The content of water in polymer membranes is generally expressed as the number of grams of water contained in per gram of dry polymer membranes, or as the number of water molecules present in each sulfonate group of polymers. The CCM 8 of FIG. 1 is capable of absorbing more water in a liquid environment with shorter water equilibration time as compared to a gaseous environment according to Schroeder paradox. One explanation for the difference between water absorption in the gaseous environment and the liquid environment is that: water absorbed in the gaseous environment contains condensate water inside the polymers, mostly on highly hydrophobic polymer backbones, thereby causing the absorbed water to be less than that absorbed directly from the liquid environments. According to relevant articles, the amount of water absorbed by the membranes in liquid water for 48 h is 1139% of the amount of that absorbed by dry membranes, while the amount absorbed by the membranes in gaseous water for 20 days is only 41.4% of the amount that absorbed by the dry membranes.

Moreover, the anodic gas diffusion layer 4 and the cathodic gas diffusion layer 5 covering both sides of the CCM 8 as key functional components of the MEA 9 are generally hydrophobic, and thus prevent liquid water from permeating into the CCM 8 on the inner side via them. Thus, when liquid water or gas containing liquid water is pumped into the cathodic gas channel 10 and the anodic gas channel 11, the liquid water therein will be difficult to penetrate the anodic gas diffusion layer 4 and the cathodic gas diffusion layer 5 to reach the CCM 8.

Based on the above premise, the present disclosure provides a novel MEA humidifying method. The key point of the method is to introduce gaseous water into the cathodic gas channel 10 and the anodic gas channel 11, and after the gaseous water smoothly penetrates the anodic gas diffusion layer 4 and the cathodic gas diffusion layer 5 to reach the CCM 8, the gaseous water is cooled to condense it, so that more obtained liquid water is capable of being absorbed by the CCM 8 within shorter water equilibration time to bring the CCM 8 to a good wetting state. The above method comprises a phase transition process of water from a gaseous state to a liquid state, which is capable of avoiding hydrophobic defects of the gas diffusion layers 4, 5 (in terms of wetting) by gaseous water, and also is capable of enabling the CCM 8 to achieve a better wetting state in liquid water environments.

Specifically, FIG. 2 shows a flow chart of the MEA humidifying method according to one example of the present disclosure. As noted above, the MEA forms a part of the PEMFC. The method uses water vapor to humidify the MEA, which reduces costs compared to the adoption of nitrogen containing water vapor. To improve the moisture effect, the method preferably adopts saturated water vapor to humidify the MEA. Referring to FIG. 2, the MEA humidifying method according to the present disclosure comprises steps 102-106.

In the step 102, the MEA is heated to a temperature greater than or equal to that of the saturated water vapor described above. In the case where the MEA forms a part of the PEMFC, the PEMFC is heated to a temperature greater than or equal to that of the saturated water vapor described above. The purpose of the step 102 is to prevent the saturated water vapor that is subsequently introduced into the PEMFC from condensation prior to penetrating the gas diffusion layers, which will be described in further detail below.

Next, in the step 104, saturated water vapor is directed to both sides of the MEA 9, such that the saturated water vapor is capable of passing through the anodic gas diffusion layer 4 and the cathodic gas diffusion layer 5 of the MEA 9 and reaching the CCM 8. Specifically, directing saturated water vapor to both sides of the MEA 9 comprises: directing the saturated water vapor into gas channels 10, 11 of the first bipolar plate 6 and the second bipolar plate 7, such that the saturated water vapor is capable of permeating the gas diffusion layers 4 and 5 from the gas channels 10, 11 and reaching the CCM 8.

Then, in the step 106, the coolant is caused to flow through both sides of the MEA 9, such that the saturated water vapor reaching the CCM 8 is condensed into liquid water to form a liquid water environment at the CCM. As such, the CCM 8 is capable of rapidly absorbing more water from the liquid water environment. The above-described coolant may be deionized water or any other suitable type of coolant. In one preferred example according to the present disclosure, in the process of flow of the coolant, the saturated water vapor in the step 104 is continuously directed to both sides of the MEA 9, thereby allowing saturated water vapor to continuously reach the CCM 8 and be condensed into liquid water. In a further preferred example, the coolant may flow through both sides of the MEA 9 at a certain time interval, and the coolant may further flow through both sides of the MEA 9 at a regular time interval. That is, the coolant does not continuously flow through the MEA 9 but stops for a period of time after flowing for a certain amount of time and then flows through both sides of the MEA 9 again, such cycle is repeated for many times. Among them, during the above-mentioned flow of the coolant, not only will the water vapor at the CCM 8 be condensed into liquid water to be absorbed by the CCM 8, but a portion of the water vapor within the gas channels will also be condensed into liquid water within the channels. This part of liquid water gradually accumulates, causing a risk of clogging of the gas channel. As a result, during the above-mentioned stoppage of flow of the coolant, the water vapor that is continuously introduced into the gas channel is capable of blowing out the liquid water in it, thereby avoiding clogging of the gas channel.

In the step 102, heating MEA 9 may be performed by any suitable method. In one example, the PEMFC can be allowed to reach a higher temperature by placing it in a high temperature cabin for a period of time. In another example, the PEFMC may also be heated using saturated water vapor due to the fact that the temperature of the saturated water vapor reaches 100° C. at ambient pressure. In this instance, the PEMFC is brought to a higher temperature by continuously introducing the saturated water vapor at the high temperature into the gas channels and/or coolant channels of the first bipolar plate 6 and the second bipolar plate 7. Due to the low initial temperature of the PEMFC, a certain amount of condensate water will initially be produced within the PEMFC when the saturated water vapor at the high temperature is introduced. However, it will be understood that since the water vapor is continuously introduced, the resulting condensate water will be taken away by the water vapor that is continuously introduced, without clogging the gas channels and/or the coolant channels.

In one preferred example, the saturated water vapor used in the step 102 and the saturated water vapor used in the step 104 may be from the same water vapor source. Further, the temperature of the saturated water vapor used in the step 102 and the saturated water vapor used in the step 104 may be equal. In this instance, the PEMFC may be heated to a temperature greater than or equal to a temperature of the saturated water vapor used in the step 104, which can not only prevent condensation of the water vapor that is introduced in the step 104, but also reduce the number of equipment required to implement the MEA humidifying method according to the present disclosure, thereby reducing the implementation cost.

In one specific example according to the present disclosure, in the step 102, the saturated water vapor is introduced into at least one of the gas channels and the coolant channels of the PEMFC to heat the PEMFC to 100-105° C. Then, in the step 104, the saturated water vapor is continuously introduced into the gas channels for a fixed time, such as 10 minutes, to allow the saturated water vapor to penetrate the gas diffusion layers to reach the CCM 8. Next, in the step 106, deionized water at about 80° C. is allowed to flow through the coolant channels 12 of the first bipolar plate 6 and the second bipolar plate 7 of the PEMFC for 30 seconds before stopping for 30 seconds, and then the deionized water starts to flow through the coolant channels 12. Such cycle is repeated for 15 times to bring the PEMFC to a good wetting state. Those skilled in the art will appreciate that the heating temperature of the PEMFC, the temperature of the saturated water vapor, and the temperature of the coolant may be adjusted, and the flow duration and period, etc. of the water vapor and the coolant may be adjusted, in order to achieve the desired wetting effect.

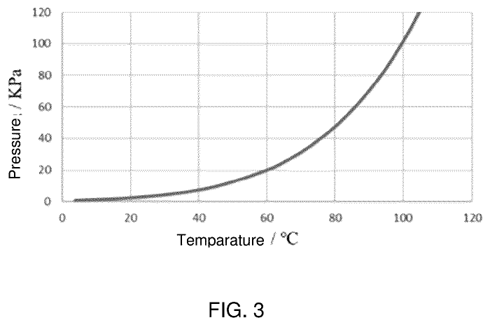

FIG. 3 shows a graph of relation of pressure versus temperature of saturated water vapor, with a general trend of: the higher the pressure of saturated water vapor, the higher the temperature. As shown in FIG. 3, at the atmospheric pressure of 100 KPa, the temperature of the saturated water vapor is 100° C. In one example according to the present disclosure, partial vacuum conditions may be applied to the saturated water vapor, so that its temperature is below 100° C. As such, the MEA may be wetted with saturated water vapor below 100° C., which helps reduce energy consumption in implementing the MEA humidifying method according to the present disclosure.

The MEA humidifying method of any of the examples described above is capable of achieving efficient wetting of the MEA alone without subsequently combining with discharge activation commonly used in the art, thereby shortening wetting time and saving wetting costs.

According to another example of the present disclosure, a computer readable storage medium is also provided. The computer readable storage medium has a program stored thereon. The program comprises instructions, and the instructions, when executed by a processor, cause the processor to perform the membrane electrode assembly humidifying method according to any of the above examples.

Although the present disclosure has been described in connection with the specific examples described above, it should not be understood that it is limited in any way to the examples presented. The scope of the present disclosure is set forth in the appended claims. In the context of the claims, the term “comprise” or “include” does not preclude other possible elements or steps. In addition, references to, for example, “a” or “an” should not be construed as excluding more than one. The use of reference symbols for the elements shown in the drawings in the claims should also not be construed as limiting the scope of the present disclosure. Further, various features mentioned in the different claims may be combined in a favorable manner, and reference of these features in the different claims does not exclude that the combination of these features is not possible and advantageous. Moreover, “first,” “second,” and “third” used in the present disclosure, among others, are merely used to distinguish the relevant components and are not intended to confer upon them attributes of any priority aspect.

What is claimed is:

1. A membrane electrode assembly humidifying method, wherein the membrane electrode assembly comprising a catalyst-coated membrane, and an anodic gas diffusion layer and a cathodic gas diffusion layer positioned on both sides of the catalyst-coated membrane, respectively, and wherein the membrane electrode assembly humidifying method uses water vapor to humidify the membrane electrode assembly, and wherein the membrane electrode assembly humidifying method comprises:
a) heating the membrane electrode assembly to a temperature greater than or equal to that of the water vapor;
b) directing the water vapor to both sides of the membrane electrode assembly to pass the water vapor through the anodic gas diffusion layer and the cathodic gas diffusion layer to reach the catalyst-coated membrane; and
c) allowing a coolant to flow through both sides of the membrane electrode assembly to condense the water vapor reaching the catalyst-coated membrane into liquid water.

2. The membrane electrode assembly humidifying method according to claim 1, wherein during step c), the water vapor in step b) is continuously directed to both sides of the membrane electrode assembly.

3. The membrane electrode assembly humidifying method according to claim 1, wherein the water vapor used by the membrane electrode assembly humidifying method is saturated water vapor.

4. The membrane electrode assembly humidifying method according to claim 1, wherein in step a), the membrane electrode assembly is heated using saturated water vapor.

5. The membrane electrode assembly humidifying method according to claim 4, wherein the saturated water vapor used in step a) is from the same water vapor source as that used in the step b).

6. The membrane electrode assembly humidifying method according to claim 5, wherein a temperature of the saturated water vapor used in the step a) is equal to a temperature of the water vapor used in the step b).

7. The membrane electrode assembly humidifying method according to claim 1, wherein in step c), the coolant flows through both sides of the membrane electrode assembly at a certain time interval.

8. The membrane electrode assembly humidifying method according to claim 7, wherein the coolant flows through both sides of the membrane electrode assembly at a regular time interval.

9. The membrane electrode assembly humidifying method according to claim 1, wherein a first polar plate and a second polar plate are formed on both sides of the membrane electrode assembly, respectively, wherein an anodic gas channel for anodic gas to flow into the membrane electrode assembly and a coolant channel are formed in the first polar plate, a cathodic gas channel for cathodic gas to flow into the membrane electrode assembly and a coolant channel are formed in the second polar plate, and wherein in the step a), the membrane electrode assembly is heated by introducing saturated water vapor into at least one of the anodic gas channel and the coolant channel of the first polar plate and the cathodic gas channel and the coolant channel of the second polar plate.

10. The membrane electrode assembly humidifying method according to claim 9, wherein in the step b), the water vapor is introduced into the anodic gas channel of the first polar plate and the cathodic gas channel of the second polar plate, so that the water vapor passes through the anodic gas diffusion layer and the cathodic gas diffusion layer to reach the catalyst-coated membrane.

11. The membrane electrode assembly humidifying method according to claim 10, wherein in the step c), the coolant is allowed to flow through the coolant channel of the first polar plate and the second polar plate to condense the water vapor reaching the catalyst-coated membrane into liquid water.

12. The membrane electrode assembly humidifying method according to claim 11, wherein in step a), the membrane electrode assembly is heated to 100-105° C.; in step b), the water vapor is continuously introduced into the anodic gas channel of the first polar plate and the cathodic gas channel of the second polar plate for 10 minutes; and in the step c), a coolant at 80° C. is allowed to flow through the coolant channels of the first polar plate and the second polar plate for 30 seconds before stopping for 30 seconds, followed by starting to allow the coolant to flow through the coolant channels, and such cycle is repeated for 15 times.

13. The membrane electrode assembly humidifying method according to claim 1, further comprising applying partial vacuum conditions to the saturated water vapor so that its temperature is below 100° C.

14. The membrane electrode assembly humidifying method according to claim 1, wherein the coolant comprises deionized water.

15. A computer readable storage medium having a program stored thereon, the program comprising instructions that, when executed by a processor, cause the processor to perform the membrane electrode assembly humidifying method according to claim 1.
